(19) United States
(12) Patent Application Publication
(10) Pub. No.: US 2002/0106191 A1
(43) Pub. Date: Aug. 8, 2002

(54) Systems and methods for creating a video montage from titles on a digital video disk

(75) Inventors: David Betz, Bedford, NH (US); Mindy Lam, Los Altos, CA (US); James Grunke, Milpitas, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: VM Labs, Inc., Mountain View, CA

(21) Appl. No.: 10/041,084

(22) Filed: Jan. 4, 2002

Related U.S. Application Data
(60) Provisional application No. 60/259,973, filed on Jan. 5, 2001.

(51) Int. Cl. H04N 5/92; H04N 5/781; G11B 27/00

(52) U.S. Cl. 386/70; 386/55; 386/125

(57) ABSTRACT

Systems and methods for creating a video montage from titles on a digital video are disclosed. Montages include one or more video segments from one or more video titles assembled together into a single video montage. Systems include authoring tools for assembling montages and display tools for displaying montages. Methods include identifying video segments for incorporation into the montage, marking the segments, and using the markings to view the montage.

### CROSS-REFERENCES TO RELATED APPLICATIONS

This application claims the benefit of U.S. Provisional Application No. 60/259,973 filed on Jan. 5, 2001.

This application is being filed concurrently with related U.S. patent applications: U.S. patent application Ser. No. ______ (Attorney Docket No. 19223-001410US), entitled “Systems and Methods for Creating an Annotated Media Presentation”; and U.S. patent application Ser. No. ______ (Attorney Docket No. 19223-001510US), entitled “Systems and Methods for Creating Single Video Frame With One or More Interest Points” both filed on a date even herewith and each incorporated herein by reference for all purposes.

### BACKGROUND OF THE INVENTION

This invention relates generally to digital video disk (DVD) technology. More particularly, this invention relates to providing unique playback experience to a viewer.

In the past, audio/visual (AV) programs such as movies, television shows, music videos, video games, training materials, etc. have typically involved a single play version of the program. The user would begin play of the program and watch the program from beginning to end. A single presentation was implemented in displaying the program. A user did not have any option to view the program from a different angle, with a different soundtrack, in a different language, with subtitles, etc. because the video could not accommodate multiple options.

However, with the introduction of DVD technology, a user now has greater number of unique options to choose from. A storyline in a movie, for example, can be shot from different angles and stored as different versions on a DVD storage medium. Similarly, a movie might be sold with optional language tracks. Thus, a viewer could decide to watch the movie with a French language track rather than English, for example. As another example, a movie might be presented with different endings. Thus, a user could select a preferred ending option before playing the movie.

In addition, DVD technology provides a viewer with unique menuing options prior to the actual play of the DVD. Such menuing options may include the ability to view deleted scenes, the movie trailer, a director narrative, the making of special effects, or actor biographies, to name a few. Menuing options may provide “behind the scenes” insight into the movie or provide the viewer with information reorganized in a format that is otherwise not available. Anything that enhances the story and adds to the all-around movie environment creates a more enjoyable movie viewing experience for the viewer.

Thus, there is a need for a device and method which is capable of creating and providing unique playback options to a viewer of a DVD. There is also a need for a system and method that allows a creator of a DVD title to provide the viewer with options that may be of interest without disturbing the integrity of the titles contained on the DVD itself.

### SUMMARY OF THE INVENTION

The present invention provides systems and methods for compiling video segments from a digital video into a single video montage. First, the video segments are identified from the titles on the DVD. Then, the video segments are assembled to create the single video montage. Finally, the identifiers, or markers, for the single video montage are stored. In some embodiments, the markers delineate a start point and an end point for each of the video segments in the video montage. In other embodiments, the marker comprises a duration of the video segment.

In some embodiments, the markers are stored on a medium separate from the title on the digital video. In other embodiments, the markers are stored on the medium with the digital video. In some embodiments, both the markers and the digital video are stored on a DVD.

The method can be implemented using a software layer running in the background of a DVD player. As such, an enhanced DVD that is compatible with the software can control the DVD player to provide the viewer with special features. Further, this enhanced DVD technology is programmable, so that it is easy to improve and expand its capabilities.

In another embodiment, a composer for creating a video montage having one or more video segments from a digital video is provided. The composer has a user interface for entering information about a video montage. The composer provides a graphical representation of the length of the video montage. In addition, the composer has a video clip chart for listing the video segments. The order of the video segments in the video clip chart can be the order in which the video clips are played for the viewer. The composer can also have a video clip setting area for entering the start time and the stop time of the video segments.

Other embodiments provide methods of presenting a video montage to a viewer. Such methods can include selection of a video montage to be displayed, retrieving portions of the video montage based on markers or identifiers, and displaying the retrieved portion.

Other and further advantages and features of the invention will be apparent to those skilled in the art from a consideration of the following description taken in conjunction with the accompanying drawings wherein certain methods and apparatuses for practicing the invention are illustrated. However, it is to be understood that the invention is not limited to the details disclosed but includes all such variations and modifications as fall within the spirit of the invention and scope of the appended claims.

### BRIEF DESCRIPTION OF THE DRAWINGS

FIG. 1 is a system drawing for implementing the present invention;

FIG. 1A is a block diagram of a development system for creating work-in-progress and run time files in accordance with the present invention;

FIG. 1B is a block diagram of Nuon™ system;

FIG. 1C is a block diagram of a media processing system;

FIG. 2 shows a video montage created from several video clips;

FIG. 2A illustrates an individual video clip;

FIG. 3 shows an embodiment for a strobing display of video segments;

FIG. 3A shows an embodiment for a multi-view display; and

FIG. 4 is a viddie menu for presenting one or more video montages to a viewer;

FIG. 5 is a video composer for creating a video montage;

FIG. 6 is a clip setting GUI for entering the start time and stop time of various video clips in a video montage;

FIG. 7 is a video clip chart for displaying the video clips in a video montage;

FIG. 7A is a flow chart outlining the steps for creating a video montage from one or more video clips from a title on a DVD; and

FIG. 8 is a simple circuit diagram for implementing the present invention.

### DESCRIPTION OF THE SPECIFIC EMBODIMENTS

The invention provides exemplary systems and methods for creating a compilation of video clips from one or more titles on a DVD. The video clips are extracted from a completed film using software, so additional editing or replication of the film is unnecessary. In addition, the video clips may be taken from all of the titles on a DVD, so the main feature, as well as theatrical trailers, deleted scenes, alternate views, and director's cuts can be used in a compilation.

As used herein, the term “viddie montage” may be used to refer to a compilation of video clips. A viddie montage is a thematic collection of shots, scenes or sequences, and is typically made up of viddie clips (segments of a video presentation). Individual video clips may be referred to as “viddie clips.” A viddie clip is the smallest unit within a viddie montage, and can be an individual shot, scene, or sequence defined by an “in” and an “out” runtime. As one skilled in the art can appreciate, the terminology used to identify and describe the individual clips and the compilation should in no way limit the scope of the invention.

Moreover, the invention described herein will occasionally be described in terms of a NUON™ system. As one skilled in the art can appreciate, any software enhanced digital playback device system may be used, but for ease of description and general understanding, the following description will be described in terms of a NUON™ system.

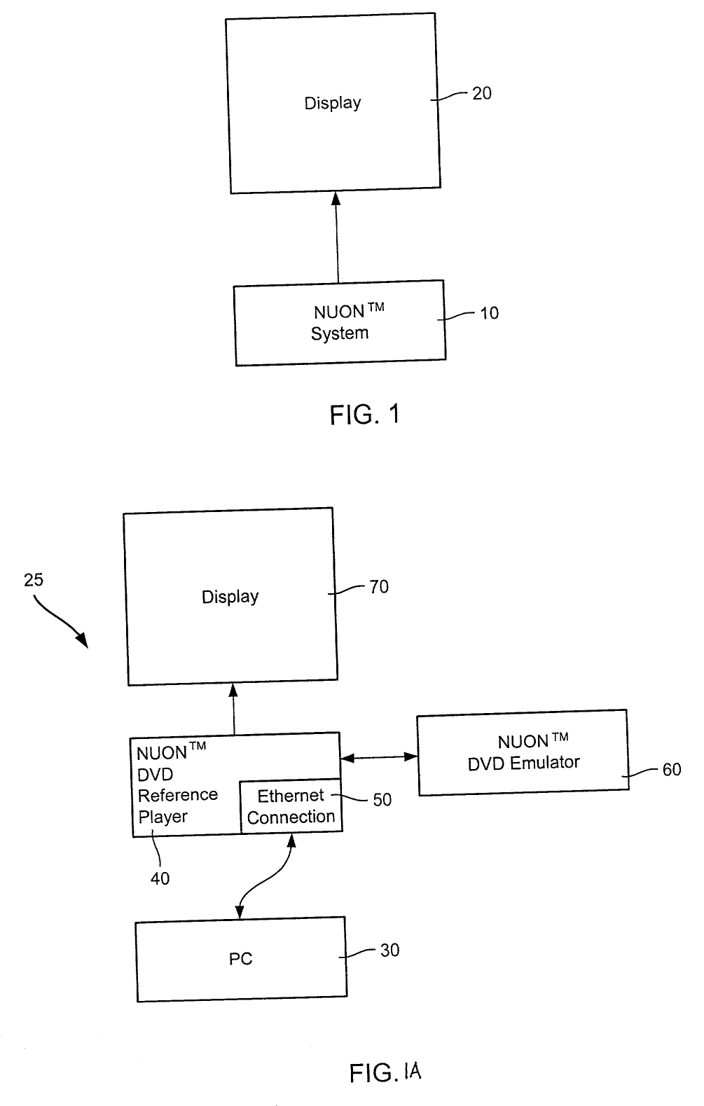

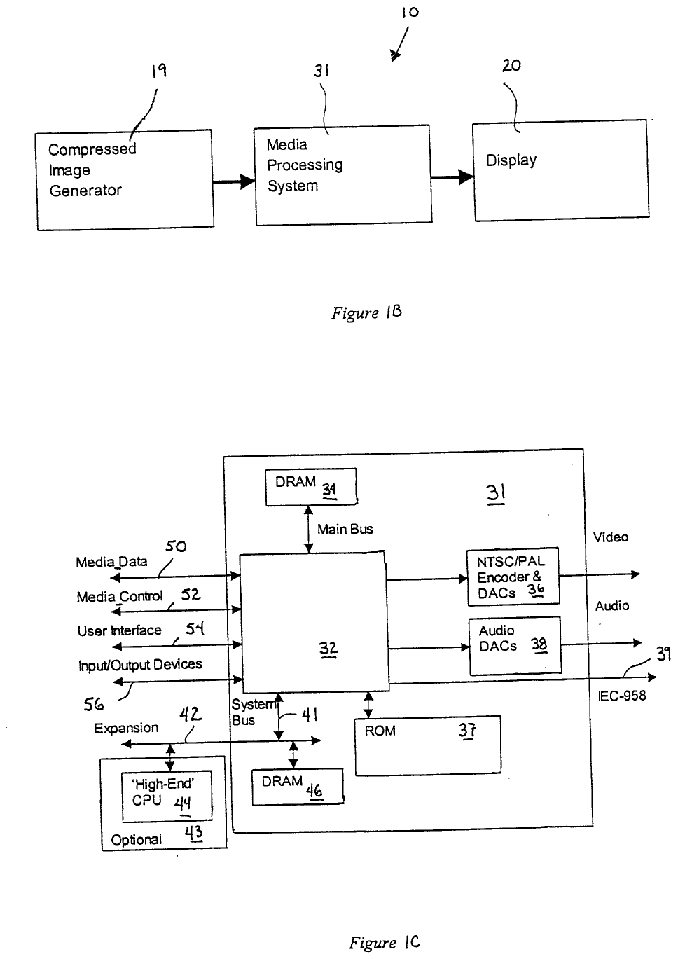

FIG. 1 illustrates a basic configuration for implementing the various embodiments of the present invention. Other configurations may be utilized, however, the illustrated configuration provides a simple yet effective implementation. As shown, NUON™ system 10 is a combination programmable single chip media processor with system and application software that enables hardware manufacturers to develop sophisticated and highly interactive digital video playback device. Digital playback devices may include, but are in no way limited to, DVD players and set-top boxes to name a few. As shown, system 10 is coupled to display 20. System 10 can be a multi-chip media processor, a single chip media processor with multiple internal paths, or a single chip media processor with proper memory buffering to handle multiple data streams simultaneously.

In one embodiment, system 10 comprises a NUON™ DVD system having a software layer running in the background. The software can be similar to the operating system on a personal computer (“PC”). The software allows enhanced digital video discs to take control of the system in a similar manner to a software application that operates on a PC. Since it is software based, system 10 is programmable in much the same way as a general purpose microprocessor-based computer. Therefore, the system is easily improved and expanded.

FIG. 1A is a block diagram illustrating components of a NUON™ development system 25 for creating work-in-progress and run time files in accordance with one aspect of the present invention. Development system 25 is used by an author who creates enhanced DVD titles for use in NUON™ DVD system 10, otherwise referred to as an enhancement author. In one embodiment, development system 25 comprises a personal computer 30 coupled to a NUON™ DVD reference player 40 using an Ethernet connection 50. In another embodiment, personal computer 30 could also be a hub connected to a server, such that multiple computers would have access to NUON™ DVD reference player 40. NUON™ DVD reference player 40 is coupled to a NUON™ DVD emulator 60. In some embodiments, emulator 60 obviates the need to create a digital video disc to review an authored montage. In one embodiment, NUON™ DVD emulator 60 is a storage device such as a hard drive, and is used to emulate the operation of a DVD and for storing any work-in-progress. NUON™ DVD reference player 40 is also coupled to a display 70.

FIG. 1B is a general block diagram of an exemplary embodiment of a system 10 configured to decompress and process montages created in accordance with the invention. The system preferably includes a compressed image generator 19, such as a hard disc drive, a cable television system, a satellite receiver, or a CD or DVD player, that can generate or provide a digital compressed media stream. System 10 also includes a display 20 for displaying decompressed full-motion images. The compressed media stream, that may include audio and visual data, enters a media processing system 31 configured to decompress the compressed media stream. In addition, media processing system 31 also may process digital data contained in the compressed data stream or in another storage device or digital data source, at the same time as it decompresses the compressed media stream, thus generating other types of media data that may be used with the decompressed media stream. For example, an interactive, color, full motion video game may be created. Once all of the data has been decompressed and processed, the data is output to display 20 for viewing. For a cable or satellite television system, media processing system 31 simply may decompress the incoming compressed digital data and output the images onto display 20, which in accordance with one embodiment of the present invention, may be a television screen.

FIG. 1C is a block diagram of the architecture of media processing system 31 in accordance with one embodiment of the present invention. Media processing system 31 includes a media processor 32, which can perform a number of operations, such as decompressing compressed video data, processing digital data that may include the decompressed video data and/or other digital data to generate full-motion color images, and controlling other operations within media processing system 31. Media processor 32 may be fabricated on a single semiconductor chip, or alternatively, the components of media processor 32 may be partitioned into several semiconductor chips or devices.

Additionally, media processing system 31 can include multiple media processors 32 to handle a variety of simultaneous data streams. The multiple media processors 32 can be incorporated on a single chip or implemented using multiple chips. It should thus be recognized that a single data stream and multiple data streams may be manipulated and/or displayed in accordance with the present invention.

Media processing system 31 also preferably includes one or more storage devices 34, 46, such as DRAM, SDRAM, flash memory, or any other suitable storage devices for temporarily storing various types of digital data, such as video or visual data, audio data and/or compressed data. Any data that is to be processed or decompressed by media processing system 31 preferably can be loaded from a main memory (not shown) into DRAM and/or SDRAM, because DRAM and/or SDRAM can be accessed more rapidly due to its quicker access time. Data that has been processed by media processing system 31 may be temporarily stored in the DRAM and/or SDRAM either before being displayed on the display or before being returned to the main memory. Various memory configurations are possible in accordance with the present invention. For example, where two media processors 32 are implemented, each may have a separate internal memory, or each may share a common memory.

When processing multimedia data, media processor 32 is configured to generate a digital image data stream and a digital audio data stream. A video encoder and digital-to-analog converter (DAC) 36 converts the digital image data output from media processor 32 into analog image signals, such as composite video, s-video, component video, or the like that can be displayed on a display device, such as a television or a computer monitor. An audio digital-to-analog converter (DAC) 38 converts the digital audio signals output by media processor 32 into analog audio signals (preferably about 2-8 separate audio channels) that can be broadcast by an audio system, or the like. In accordance with an alternative embodiment, media processor 32 also may output an IEC-958 stereo audio or encoded audio data signal 39, which is an audio output signal intended for connection to systems which may have internal audio decoders or digital-to-analog converters (DACs).

Media processor 32 also may include a second storage device 37, such as a read only memory (ROM) or the like, which can be used to store a basic input/output operating system (BIOS) for media processing system 31, audio tables that may be used to decompress the audio data and generate synthesized audio, and/or any other suitable software or data used by media processor 32 and media processing system 31. Media processor 32 further may include an expansion bus 42 connected to a system bus 41, so that one or more expansion modules 43 may be connected to media processor 32. Expansion module 43 may include additional hardware, such as a microprocessor 44 for expanding the functionality of media processing system 31. As illustrated in FIG. 1C, additional memory 46 also may be connected to processor 32 via expansion bus 42 and system bus 41.

As just one example, expansion module 43 may be a PC allowing interaction of a user with media processing system 31. Such interaction may include the creation of a viddie montage as described blow, the selection of a viddies montage for play back, and/or storage of a custom montage created by an end viewer.

Media processor 32 preferably includes several communication connections for communicating between media processor 32 and the rest of media processing system 31. A media data connection 50 permits the transfer of media data between media processor 32 and other systems, such as compressed image generator 19 (FIG. 1B). A media control connection 52 transfers control signals and/or data between media processor 32 and other systems, such as I²C compatible devices and/or interface hardware connected to system bus 41. A user interface connection 54 transfers user interface data between media processor 32 and user interface peripherals, such as joysticks, IR remote control devices, etc. Finally, an input/output channel connection 56 allows for connections to other I/O devices for further expansion of the system.

Media processing system 31 may be used for a variety of applications, such as full-motion color video games, cable and satellite television receivers, high definition television receivers, computer systems, CD and DVD players, and the like. For example, in a video game application, digital data representing terrain, action figures, and other visual aspects of a game may be stored in main memory or input from a peripheral digital data source. In accordance with this aspect of the invention, media processing system 31, and more particularly processor 32, processes the digital data from one or more digital data sources, generating interactive full-motion color images to be displayed on a video game display. Media processing system 31 also may generate audio signals that may add music and sound effects to the video game.

For a cable or satellite television receiver, media processing system 31 decompresses compressed digital video and audio signals received from a cable head end system or satellite transmitter, and generates decompressed digital video and audio signals. The decompressed digital video and audio signals then are converted into analog signals that are output to a television display. Media processing system 31 also may be configured to decrypt any encrypted incoming cable or satellite television signals.

For a DVD player, media processing system 31 preferably receives compressed digital data from a DVD or CD, and decompresses the data. At the same time, media processing system 31 may receive digital data stored on a ROM, for example ROM 40, or input from another digital data source, and generate a video game environment in which the decompressed DVD or CD color images are displayed along with the data received from the ROM or other digital data source. Thus, an interactive, full-motion, color multimedia game may be operated by media processing system 31.

One of ordinary skill in the art will recognize that other systems are possible for processing and/or creating montages according to the present invention. Details of other processing systems and elements thereof are provided in U.S. patent application Ser. No. 09/476,761 (Attorney Docket No. 19223-000100US), filed Jan. 3, 2000, and entitled “A Media Processing System And Method”, the entirety of which is incorporated herein by reference for all purposes; U.S. patent application Ser. No. 09/476,946 (Attorney Docket No. 19223-000600US), filed Jan. 3, 2000, and entitled “Communication Bus for a Multi-processor System”, the entirety of which is incorporated herein by reference for all purposes; U.S. patent application Ser. No. 09/476,698 (Attorney Docket No. 19223-000700US), filed Jan. 3, 2000, and entitled “Subpicture Decoding Architecture And Method”, the entirety of which is incorporated herein by reference for all purposes.

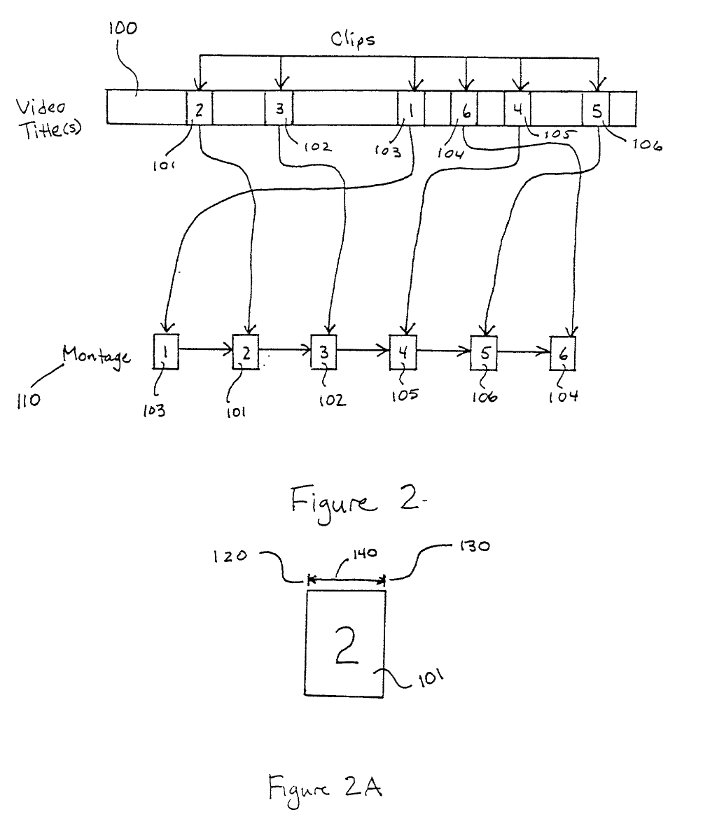

FIG. 2 illustrates the parsing of a video title 100 into individual video segments or viddie clips 101, 102, 103, 104, 105, 106. In one embodiment, video title 100 may be a single movie title or it may be several video titles on a DVD. The viddie clips are then assembled to form the viddie montage or video montage 110. Note in the illustration that viddie clips 101, 102, 103, 104, 105, 106 are taken from video title 100 in a scrambled order. This example illustrates that viddie clips may be pulled from any part of a title, and thereafter arranged in any order in the montage. Moreover, viddie clips may be pulled from any title that appears on the DVD, including director's cuts, deleted scenes, and theatrical trailers. FIG. 2A further illustrates an individual viddie clip 101. The total run time 140 of viddie clip 101 is determined by specifying a punch-in time 120 and a punch-out time 130.

In some embodiments, the minimum run time for a viddie is one video frame. Thus, the system can be used to create still images from digital video title 100. Such still images can be used to create a “hyper slide” of a scene from video title 100. The hyper slide can then be used, for example, to form a graphical table of contents of all portions of video title 100, of all available video montages 110, or of a director's script. One of ordinary skill in the art will understand that many possible uses for such hyper slides exist. For example, such a hyper slide may be marked up when authoring a director's script as described in U.S. patent application Ser. No. ______ (Attorney Docket No. 19223-001410US), entitled “Systems and Methods for Creating an Annotated Media Presentation”.

In other embodiments, the minimum time for a viddie is two seconds to assure that enough contextual material is included to understand the viddie clip. Other minimum viddies lengths are possible in accordance with the present invention.

Viddie montage 110 adds value to a DVD title by creating thematic montages of viddie clips. For example, a montage could be compiled for explosions in an action film, or kisses in a romantic drama, or explosive-corrosive-acid-soaked-kisses in a sci-fi thriller. For example, assume a studio is putting out a sci-fi thriller and wants to assemble a kissing viddie montage. All the kissing parts of the film would be identified as well as their respective DVD run-times 140, including the punch-in time 120 and the punch-out time 130. This identification and compilation generates a run list for a single viddie montage 110 with each of the kissing scenes, which are viddie clips, and their individual in and out time codes. As will be described hereinafter, each viddie clip may have descriptive text relating its importance to the viddie montage, which is shown in a viddies menu.

Also, in some embodiments a series of hyper slides portraying various actors in the video presentation can be assembled for display with the credits associated with the presentation. In such embodiments, the hyper slides may be displayed in one window while the credits portion of the presentation are played in another window. Both windows can be active video windows, or one window can be an active video window for displaying the credits, while the other window is a graphical window for displaying the hyper slide associated with the credits. In another embodiment, viddie clips portraying the various actors in the video presentation can be assembled for display with the credits. In such an embodiment, the viddie clip can be displayed simultaneously with a selected portion of the video presentation, where the viddie clip is displayed in one active video window and the video presentation in another active video window.

A hyper slide can be any image or series of images selected for its relationship to a video presentation. For example, a hyper slide may include a single frame of video showing a costume worn by an actor in a video presentation. Such a hyper slide may be an actual image taken from the video presentation, or an image taken of the actor apart from the video presentation.

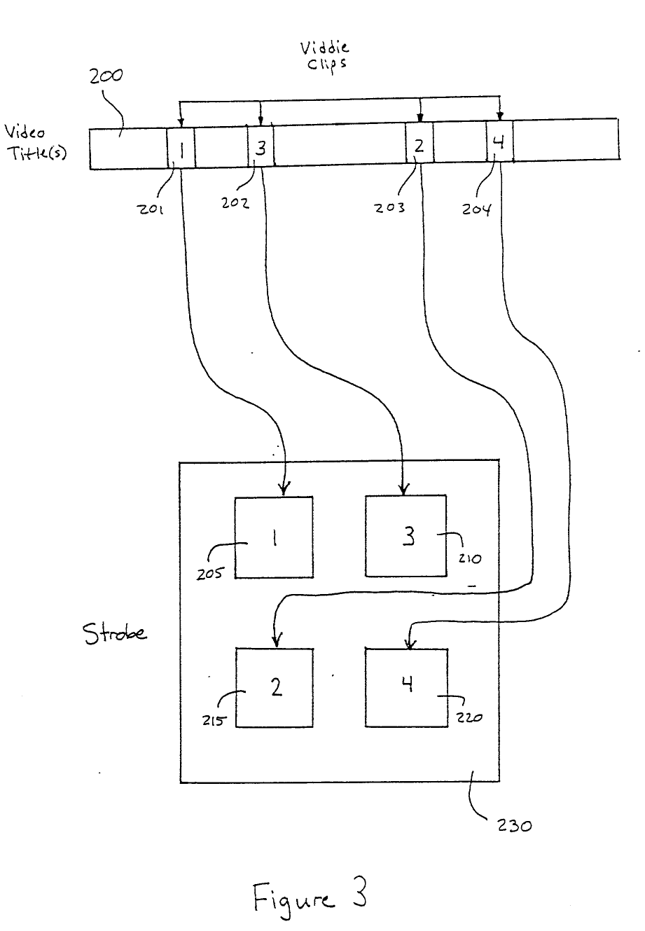

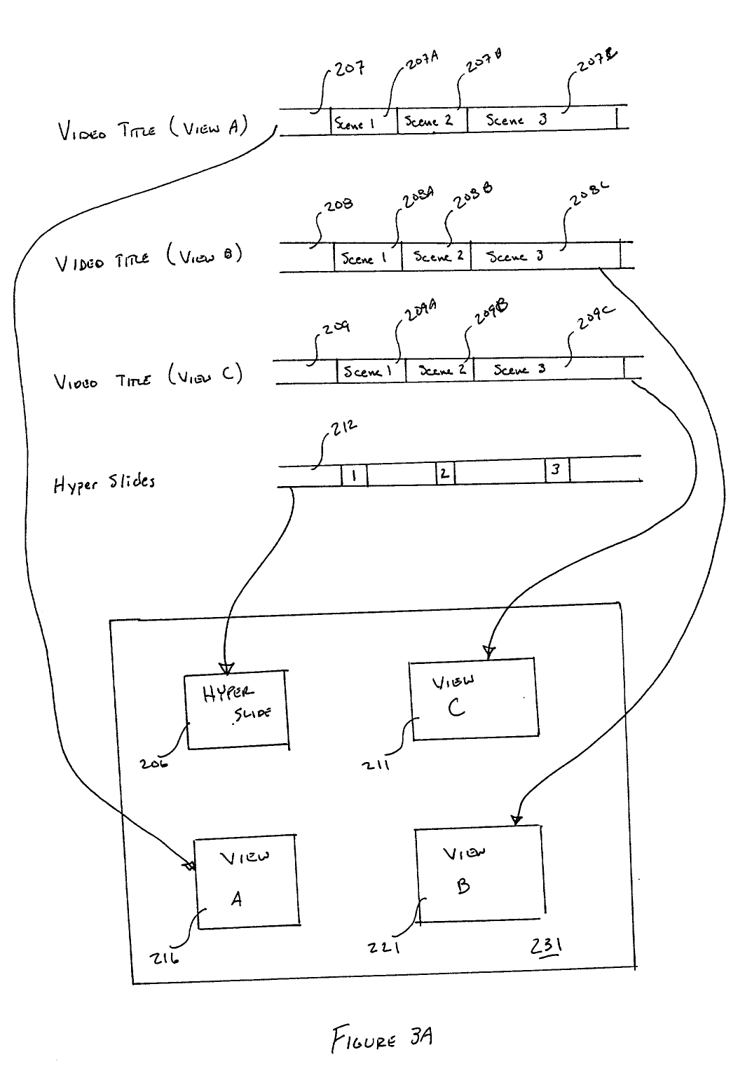

FIG. 3 illustrates an embodiment wherein viddie clips 201, 202, 203, 204 are again parsed and identified from video title 200, but displayed in a strobing style. As illustrated, the identified viddie clips 201, 202, 203, 204 are displayed on display 230. Strobing involves showing a single frame of each video clip for each quadrant in rapid succession. In the illustrated example, the first frame of viddie clip 201 is shown in quadrant 205. Then, the first frame of viddie clip 202 is shown in quadrant 210. Continuing, the first frame of viddie clip 203 is shown in quadrant 215. Finally, the first frame of viddie clip 204 is shown in quadrant 220. The process is then repeated for quadrant 205 and each of the three quadrants in succession. The speed of the strobing can be varied and established by the DVD author. Other embodiments could increase the number of locations for viewing viddie clips or strobe in a different manner, such as showing the first frame, second frame, third frame, etc. for each clip simultaneously.

FIG. 3A illustrates an embodiment wherein video views 207, 208, 209 are each displayed simultaneously in different active windows 211, 216, 221. Thus, for example, video view A 207 can be an overhead view of a scene, video view B 208 can be a side shot of the scene, and video view C 209 can be a different side shot of the scene. Display 231 shows all views presented simultaneously along with a hyper slide 206. Hyper slide 206 can be a single frame of the scene being displayed in active video windows 211, 216, 221. Allowing a user to see all views of a scene on display 231 enhances the viewing experience.

Video views 207, 208, 209 can be simultaneously displayed using multiple media processing systems 31, a media processing system 31 with multiple display paths, and/or using a single media processing system 31 with a single display path by multiplexing the display path and buffering various display steeams to smooth the video output.

Alternatively, in some embodiments, viddie clips can be marked as previously discussed to select view A 207 of scene 1 (207A, 208A, 209A) and alternative views 208, 209 for other scenes 208A, 208B, 208C, 209A, 209B, 209C. The marked scenes can then be assembled into a single video montage to create a video title with customized scene views.

In some embodiments, the viddie clip montages can be created by an end user using an enhanced DVD player coupled to a PC. In other embodiments, the viddie clip montages can only be created by an author who stores the montage as an alternate title on a DVD. Such alternate titles can be in addition to the main title on the DVD.

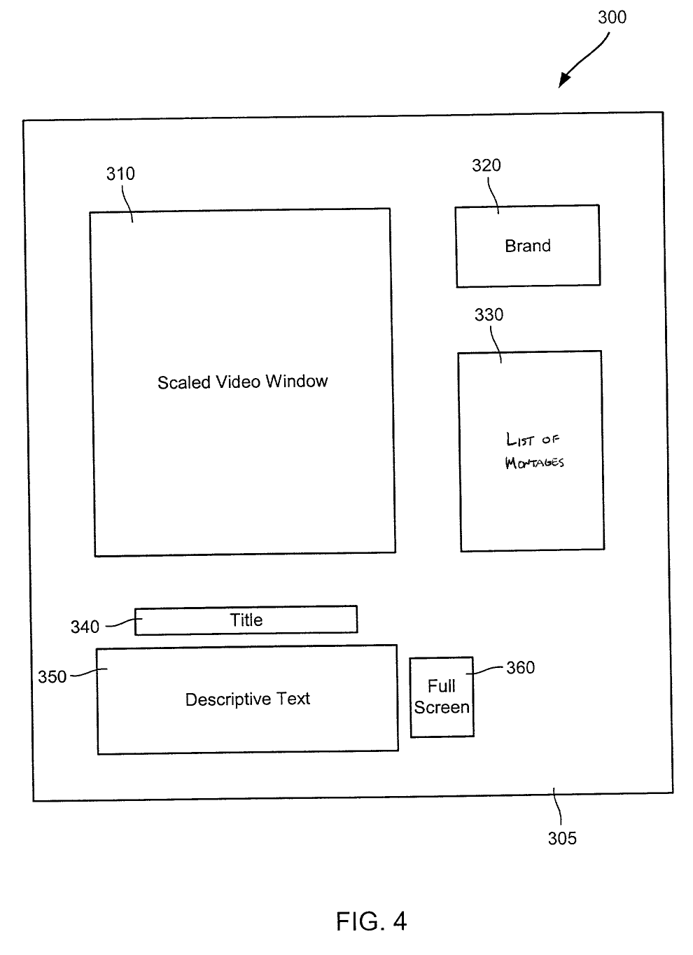

FIG. 4 illustrates a typical embodiment of a viddies menu 300 in accordance with one embodiment of the invention. Viddies menu 300 organizes all the created viddie montages into a single location for selection by a viewer of an enhanced DVD. As shown, viddie menu 300 is shown on display 305. Viddie menu has a scaled video window 310 for displaying a small scale version of a selected viddie montage. A particular viddie montage is selected by a viewer from a list of viddie montages 330. Although not illustrated in FIG. 4, list 330 shows all the montages created for the enhanced DVD. Viddie menu also has an area for a title of the viddie montage 340 and an area for descriptive text of the viddie montage 350. Both the title and the descriptive text correlate to the video clip shown in scaled down window 310.

Continuing with the description of the figures, in one embodiment, viddie menu 300 illustrated in FIG. 4 is a full screen bitmap image (720×480 pixels) much like any typical piece of DVD menu artwork. However, the illustrated menu has a “picture-in-graphic” display. As such, although not apparent from this drawing, moving video actually appears in scaled video window 310 in real time. Another novel aspect of features menu 300 is that text in title area 340 and descriptive area 350 can be displayed dynamically. Therefore, menu items in montage list 330 or other text such as the descriptive text or title is not included in the bitmap image. This text is displayed by software, and is based on the text that is entered into a viddie composer described hereinafter. Other graphic items, such as logos and heading text 320, will still be part of the background bitmap.

In operation, the viewer observes a particular montage by simply selecting the viddies menu, navigating to the desired viddie montage in list 330, and selecting the particular montage for viewing. In some embodiments, the montage list 330 indicates the titles of the various montages, while in other embodiments, montage list 330 contains a number of hyper slides each graphically depicting the various montages. The montage will be shown in scaled video window 310 with the corresponding title 340 and descriptive text 350. Alternatively, area 350 can be filled with a hyper slide of an ongoing scene displayed in scaled video window 310. If the viewer wishes to see the viddie montage on a full screen, they simply select full screen option 360.

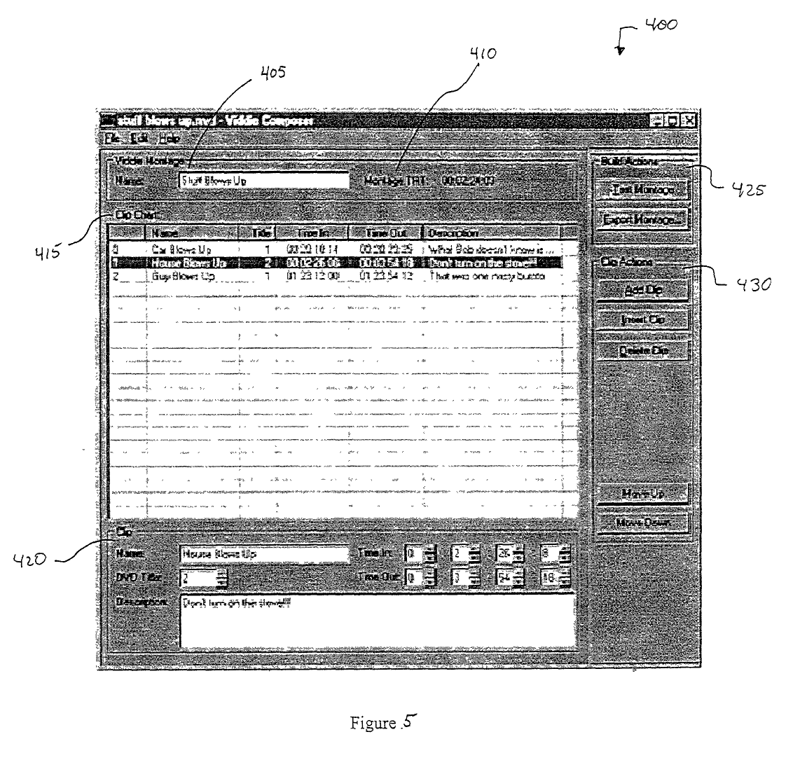

FIG. 5 illustrates one embodiment of a viddie composer main window 400. Viddie composer 400 is for entering pertinent viddie montage information, as well as for testing viddie montages for timing accuracy and thematic flow. As illustrated, viddie composer 400 is a standard window with a menu bar at the top, text entry fields, and several buttons to make selections.

In the middle of viddie composer window 400 is a viddie clip chart 415. Viddie clip chart 415 displays the viddie clip info for a particular viddie montage. Just above clip chart 415 is viddie montage name text field 405. Name text field 405 is the title of the viddie montage and as such appears as an individual menu item in viddie montage list 330 of viddies menu 300. To the right of name text field 405 is a graphical representation of the montage total run time display 410. Total run time display 410 totals the run time for all clips in the current viddie montage. As illustrated, time is shown in HH:MM:SS:FF format. To the right of clip chart 415 are the viddie action buttons 425 and 430. Action buttons 425 and 430 include, but are in no way limited to, testing the montage, exporting the montage, adding a clip, inserting a clip, deleting a clip and moving a clip up or down to name a few. Finally, below clip chart 415 is a video clip setting area 420 for entering all of the important viddie clip information.

Viddie build action buttons 425 are used to test and export viddie montages. The test montage button immediately plays the currently loaded viddie montage. When selected, the viddie montage plays and a dialog box is displayed. A progress bar indicates the approximate position in the viddie montage. The dialog disappears when the viddie montage is done playing. The export montage button exports the current viddie montage in an executable file format. In one embodiment, the file is a director script format file (e.g. *.dsb), which will run on a NUON™ system. When selected, a dialog box is displayed. A viddie montage number is selected, which in one embodiment is between 1 and 16. This number correlates to a specific entry in the viddies menu 300. Once the number has been selected, the viddie montage will be exported to the proper directory.

FIG. 6 illustrates an isolated view of video clip setting area 420. Setting area 420 establishes the settings for each individual viddie clip in a viddie montage. When a clip is added in the settings area, the initial values are set to a pre-determined default value that may be modified by the author. Moreover, setting area 420 is also used to edit a previously created viddie clip that is selected from viddie clips chart 415.

Name field 445 is illustrated in the upper left corner of video clip setting area 420. Name field 445 is used to enter the text that is displayed in viddie clip chart 415, however, this data is not used by the NUON system or displayed on any menu screen. The text entered into the name field 445 is included for the benefit of the author. Inputted text is displayed in the name column of the viddie clip chart alongside the pertinent title, time in/out, and description data for the currently selected viddie clip. Below name field 445 is DVD title information field 450. DVD Title entry field 450 operates as a text entry field with the addition of increment/decrement arrows for selection of a DVD title number that will be selected for use in the currently selected viddie clip.

User interfaces for entering the time in or punch-in time 435 and the time out or punch-out time 440 for a viddie clip are also illustrated in FIG. 6. Similar to the DVD title window 450, fields 435 and 440 are a combination of text and increment/decrement fields, where the punch-in and punch-out times of the currently selected viddie clip are entered. Times are shown in HH:MM:SS:FF format. A warning is returned for times that are out range.

Viddie clip description field 455 is for entering text that may describe the importance or relevance of the current viddie clip in relation to the whole viddie montage. Any text entered into description field 455 is displayed in the appropriate area of the viddies menu 300.

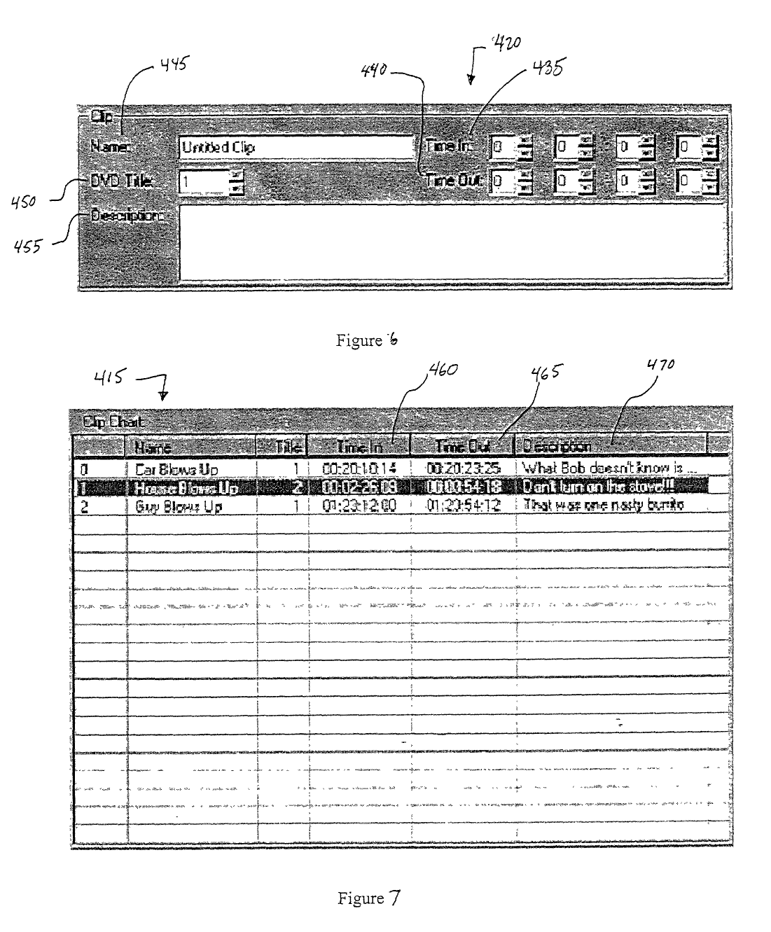

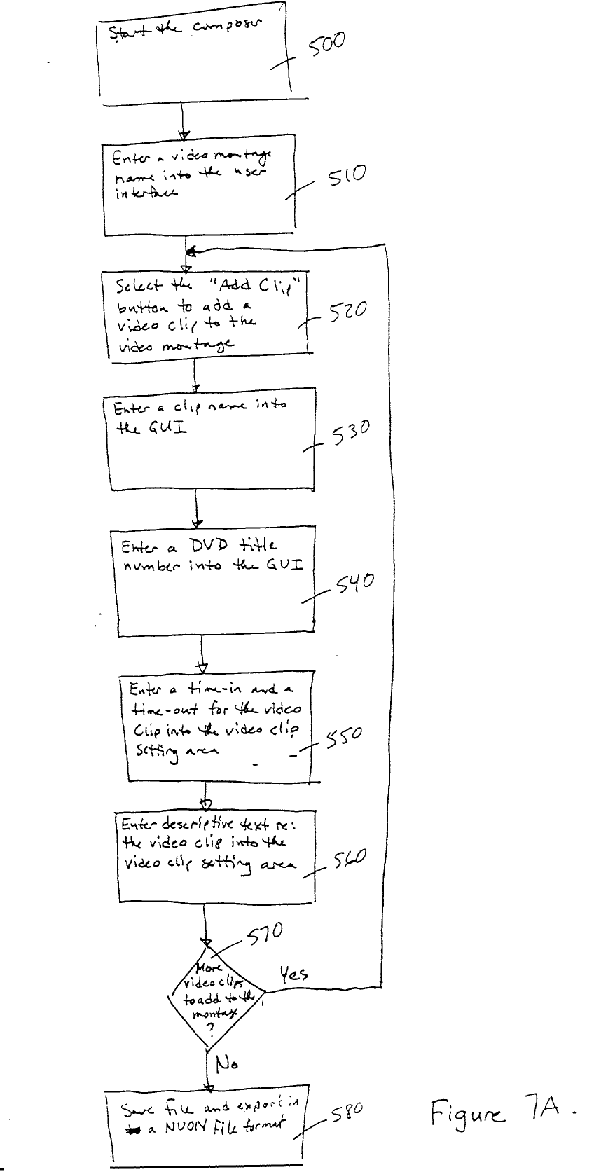

FIG. 7 shows an isolated view of clip chart 415. Viddie clip chart 415 is where an author may add, insert, delete and otherwise arrange viddie clips entered into a viddie montage. This is the main display area of viddie composer 400. Most of the other controls in the main window have a direct effect on the chart. There are no editing features for clip chart 415, only selecting individual viddie clips for editing, as well as resizing the chart columns to accommodate showing text of differing lengths. Clip chart 415 displays the time-in and time out for each viddie clip in columns 460 and 465 respectively. In addition, the description of the various viddie clips is displayed in column 470.

In the example shown in FIGS. 5, 6 and 7, the viddie montage is named “Stuff Blows Up.” This montage includes three viddie clips named “Car Blows Up”, “House Blows Up”, and “Guy Blows Up”. Each viddie clip has an associated title number, in/out times, and some descriptive text. When exported and saved as a file to an enhanced DVD, all of this information will produce a single viddie montage named “Stuff Blows Up”.

FIG. 7A illustrates a flow chart for the steps of creating a viddie montage. The viddie composer main window 400 is opened (step 500) to begin the process of entering the individual viddie clips. As shown, a viddie montage name is entered (step 510) into the user interface. Then, the “add clip” button is selected (step 520) to add a viddie clip to the viddie montage. Next, a clip name and a DVD title is entered into the user interface (steps 530 and 540). Continuing, a time in and a time out value for the viddie clip is entered into the viddie clip setting area (step 550). Then, descriptive text is entered into the viddie clip setting area as shown in step 560. If it is necessary to enter more clips into the montage, steps 520-560 are repeated for each viddie clip. If the final clip is entered, the file containing the viddie montage is saved and exported in a run time file format.

It should be noted that “add clips” append the viddie clips to the end of the chart. In addition, the viddie clips will appear in the viddie montage in the same order as they appear in the chart. Viddie clips can be played from any part of the movie in any order. The viddie montage can go from end to beginning, or skip around, and can even jump from title to title.

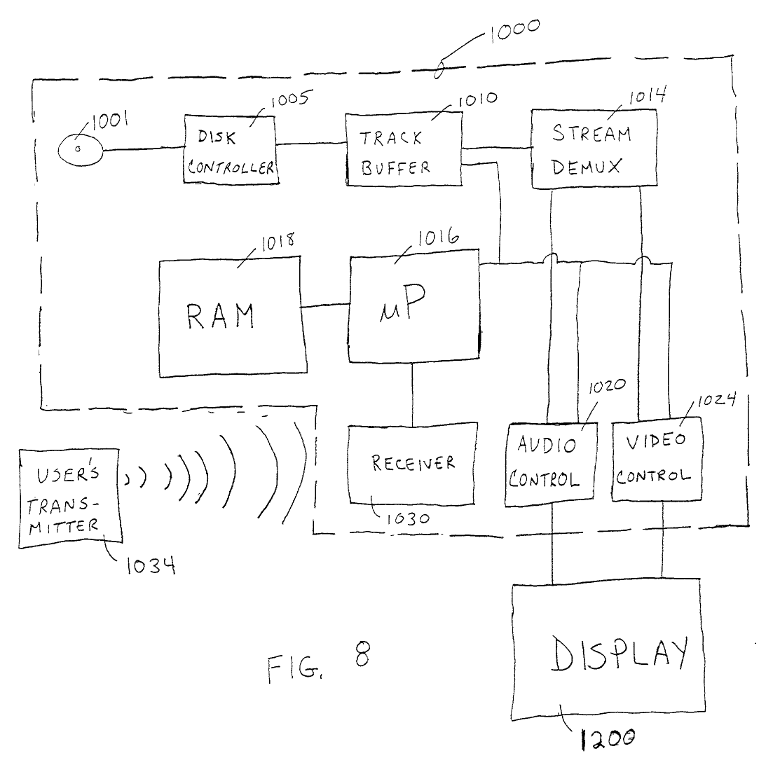

FIG. 8 illustrates a circuit for implementing the invention according to the flowchart of FIG. 7A. In circuit 1000, a DVD disc 1001 is shown coupled to a disk controller 1005. Typically a pickup will be used as a transducer to input the data from a DVD disc, for example. The disk controller is coupled to a track buffer 1010 which stores data for the presentation being displayed. This information can then be decoded by the processor. For example, the processor can separate selected chunks of data corresponding with the selected presentation for display. Similarly, the processor can be used to convert an MPEG encoded data stream to a format suitable for output. Information is conveyed from the track buffer to a stream demultiplexer 1014 in which the various audio and video streams are demultiplexed. These demultiplexed streams are subsequently conveyed to audio controller 1020 and video controller 1024.

A display 1200 receives data from the video controller and audio controller to display the presentation. A processor 1016 controls the implementation of the flowcharts described above through software. The processor is coupled to a memory such as RAM 1018. The user can provide input to the circuit through the use of a transmitter 1034, such as a remote control associated with a DVD player. The output from the transmitter is directed to a receiver 1030 which is coupled to the processor 1016. This circuit builds upon the circuit shown on page 135 of “DVD Demystified” by Jim Taylor, McGraw Hill publisher, copyright 1998, the entire content of which is hereby incorporated by reference in its entirety for all that it discloses and for all purposes.

It is thought that the apparatuses and methods of the embodiments of the present invention and many of its attendant advantages will be understood from this specification and it will be apparent that various changes may be made in the form, construction and arrangement of the parts thereof without departing from the spirit and scope of the invention or sacrificing all of its material advantages, the form herein before described being merely exemplary embodiments thereof.

What is claimed is:

1. A method for compiling video segments from a digital video into a video montage, the method comprising:
identifying a plurality of video segments from the digital video;
ordering the video segments to define the video montage, wherein the ordering comprises providing a marker for each of the video segments; and
storing the marker for each of the video segments on a storage medium.

2. The method of claim 1, wherein the marker comprises a start point.

3. The method of claim 2, wherein the marker further comprises a duration.

4. The method of claim 2, wherein the marker further comprises an end point.

5. The method of claim 1, wherein the video segments are not physically reproduced on the storage medium.

6. The method of claim 1, wherein the digital video is stored on a digital video disc (DVD) and the storage medium is separate from the DVD.

7. The method of claim 1, wherein the digital storage medium is a digital video disc (DVD), and wherein the marker and the digital video are stored on the same DVD.

8. The method of claim 1, wherein the ordering the video segments includes providing the video segments in an order different from how they appear on the digital video.

9. The method of claim 1, wherein the digital video comprises a plurality of titles.

10. The method of claim 9, wherein the plurality of titles are selected form a group consisting of a main title, a director's cut, a deleted scene, and an alternate view.

11. A composer for creating a video montage, said video montage comprising a single video clip having one or more video segments from a digital video, said composer comprising:
a user interface for entering information about the video montage;
a graphical representation of a run time of the video montage, wherein the run time represents a length of the video montage;
a clip chart listing the one or more video segments, wherein the clip chart shows the one or more video segments in replay order; and
a video clip setting area, wherein the video clip setting area has a user interface for entering at least the start time of each of the one or more video segments.

12. The composer of claim 11, wherein the video clip setting area comprises a name and description of each of the one or more video segments.

13. The composer of claim 11, wherein the video clip setting area comprises a still shot of an image associated with each of the one or more video segments.

14. The composer of claim 11, wherein the video clip setting area further comprises a user interface for selecting a video title from a digital video disc (DVD), the video title comprising the one or more video segments.

15. A system for creating a compilation of video clips from a digital video disc (DVD), the system comprising:
a DVD reference player having a communication port;
a computer coupled to the communication port;
a DVD emulator coupled to the DVD reference player for storing a work in progress and for imitating a DVD; and
a display coupled to the DVD reference player.

16. A method of presenting a video montage to a viewer, said video montage comprising a plurality of video segments from one or more digital video titles, the method comprising:
selecting a video montage to be displayed to the viewer, wherein the video montage comprises a first marker associated with a first video segment and a second marker associated with a second video segment;
using the first marker, retrieving the first video segment from a digital video disc (DVD);
displaying the first video segment;
using the second marker, retrieving the second video segment from the DVD; and
displaying the second video segment.

17. The method of claim 16, wherein the first and second video segments are displayed simultaneously.

18. The method of claim 17, wherein the first video segment is a first view of a scene and the second video segment is a second view of the same scene.

19. The method of claim 16, wherein the first and second video segments are topically related.

20. The method of claim 16, wherein the second video segment is displayed followed by the first video segment.

21. The method of claim 16, the method further comprising:
displaying a still image associated with the first video segment.

22. The method of claim 21, the method further comprising:
displaying a still image associated with the second video segment; and
selecting the still image associated with the first video segment to cause the first video segment to display and selecting the still image associated with the second video segment to cause the second video segment to display.

23. The method of claim 16, the method further comprising displaying a textual description of the first video segment coincident with displaying the first video segment.
